(19) United States
(12) Patent Application Publication
(10) Pub. No.: US 2026/0273319 A1
(43) Pub. Date: Sep. 17, 2026

(54) FIRE SUPPRESSANT DEVICE AND METHOD

(71) Applicants: Anthony Cosimano, Warwick, NY (US); Lisa A. Sasse, Warwick, NY (US); John M. Lordy, Warwick, NY (US)

(72) Inventors: Anthony Cosimano, Warwick, NY (US); Lisa A. Sasse, Warwick, NY (US); John M. Lordy, Warwick, NY (US)

(21) Appl. No.: 19/567,262

(22) Filed: Mar. 16, 2026

Related U.S. Application Data
(60) Provisional application No. 63/772,449, filed on Mar. 14, 2025.

(51) Int. Cl. A62C 3/16; A62C 31/03; A62C 99/00

(52) U.S. Cl. CPC A62C 3/16; A62C 31/03; A62C 99/0045

(57) ABSTRACT

The invention relates to a fire suppression device and method, in particular a device for delivering free-flowing granular fire suppressant media to a fire or potential fire emergency, in particular one caused by Li-ion battery failure, comprising a media reservoir adapted to supply an auger housed in a tubular barrel and mechanism for rotating the auger so as to deliver the fire suppressant media to the fire or potential fire emergency, and a method of using same to combat a fire or potential fire emergency by suppressing and/or extinguishing the fire.

### FIELD OF THE INVENTION

This invention relates to a fire suppression device and method, in particular a device for delivering free-flowing granular fire suppressant media to a fire or potential fire emergency, in particular one caused by Li-ion battery failure.

### BACKGROUND OF THE INVENTION

Lithium-ion (Li-ion) batteries, commonly used in personal electronic devices (PEDs) and transportation applications (collectively Li-ion battery containing devices), can generate excessive heat which can lead to an uncontrolled chain reaction known as a thermal runaway. This process can result in a fire, explosion, and/or the release of toxic gases. As a result, devices containing Li-ion batteries that are undergoing thermal runaway can ignite, swell, melt, boil or produce toxic smoke. At any of these stages they are risky to handle safely since they are very hot, produce toxic fumes and are at risk for sudden explosion.

Thermal runaway can occur in any type of battery, but it is particularly dangerous and difficult to extinguish when it occurs in Li-ion batteries, including those with polymer components. Thermal runaways can result from quality issues during manufacturing; battery damage due to mishandling including mechanical, thermal, or electrical abuse; overheating or exposure to temperatures outside the safe temperature range for the battery; overcharging or charging at a too high current; improper disposal; aging; or a combination of the above.

Because lithium is very reactive with water, Li-ion batteries require tightly welded outer casings to seal out all contaminants and moisture. When these protective casings fail an exothermic reaction can occur in one part of the battery, which begins to release heat and deform, and if unchecked initiates the thermal runaway cycle in which the temperature and pressure inside the battery keep increasing until it ignites or explodes. When in thermal runaway, the battery typically follows four steps: (1) it enters a self-heating state; (2) generates heat faster than it can dissipate it; (3) its temperature rises rapidly; (4) it vents smoke, catches fire, or explodes. When faced with an Li-ion fire emergency, the timing and progression through these four steps is generally unpredictable. Furthermore, if the battery has more than one cell, the initial uncontrolled heat production can result in a cascade effect from one cell to another that eventually causes a fire that is difficult to fully extinguish because each unspent cell is at risk for re-ignition.

Efforts have been made to prevent Li-ion battery thermal runaways by making the batteries themselves safer; for example by using materials that make the batteries less susceptible to overheating or by incorporating thermal management systems in the batteries or devices. However, such prevention efforts are not foolproof, and thermal runaway can still occur in any type of Li-ion battery and device containing it, including for example, mobile phones, laptops, e-cigarettes, power banks, e-book readers, cameras, video cameras, recorders, lights, flashlights, cosmetic devices, e-scooters, e-bikes, hoverboards, electric cars, power tools, lawn mowers, vacuum cleaners; and Li-ion thermal runaway incidents have been steadily increasing.

In the aviation industry Li-ion battery fires are a pressing concern. In fact, passengers are not allowed to pack PEDs in their check-in baggage because lack of ready access to the cargo area. According to FAA data, in 2023 more than one Li-ion battery incident occurred aboard an aircraft each week. Specifically, the agency reported 208 issues with Li-ion battery packs, 111 with e-cigarettes and vaping devices, 68 with cell phones and 60 with laptop computers. Such a concern is also present in other settings, including nautical, residential, office or industrial settings, for example on ships and submarines, parking garages, manufacturing plants, hospitals and even homes where electrical bicycles, scooters and cars are stored and charged and PEDs, including hand tools and vacuum cleaners are ubiquitous. For example, fire departments in New York City and San Francisco reported handling more than 660 fires involving Li-ion batteries since 2019. In New York City alone, these fires caused 12 deaths and more than 260 injuries from 2021 through early 2023. Therefore, preventing and managing Li-ion thermal runaways is of utmost importance in aviation safety as well as other industries or settings.

Li-ion battery fires, however, are challenging to handle and require special consideration. Because of their unique properties, traditional fire extinguishers like water, foam, or carbon dioxide are often not effective and risk exacerbating the fire. As discussed above, thermal runaway causes the internal temperature of the affected battery cell to rise rapidly, leading to a chain reaction that spreads fire to other cells. The internal temperature can rise in a matter of seconds to 212° F. (100° C.) and can exceed 1800° F. (1000° C.). In addition, the pressure also increases, and oxygen and toxic gases, such as hydrogen fluoride, are formed. Because they generate their own oxygen while burning, Li-ion fires are self-sustaining and can burn even in environments with low oxygen. The intense heat generated, toxic fumes and risk of explosion poses risks for operators attempting to extinguish the fire, even if the fire is small.

While it is possible to extinguish the flames by applying large amounts of water, water-based extinguishers, like water hoses or foam fire extinguishers, risk exacerbating the fire because water can react with the lithium to form flammable hydrogen gas and spread the fire. Furthermore, large volumes of water are needed to effectively cool down or submerge the fire. Extinguishers containing inert gases like carbon dioxide or nitrogen risk spreading the fire and can only suppress surface flames but cannot reach inside the battery to fully extinguish the fire, and residual heat in the battery can cause re-ignition even after the surface fire is extinguished.

In the aviation industry there is an urgent need for an immediate, effective and versatile way to manage thermal runaways due to Li-ion batteries because of their catastrophic potential, lack of access to outside firefighting resources while in the air, limited personnel and the limited weight and space available in airborne aircraft. Currently, the aviation industry is employing burn bags or blankets containing fire suppressant media. For example, CellBlock (Registered Trademark) makes Li-ion battery incident kits (LIBIK) that include a fire suppression pillow (PED-Pad) containing fire suppressant media comprising expanded glass granules, a fire shield blanket, high heat gloves and goggles. See U.S. Pat. No. 11,247,083. According to CellBlock, the PED-Pad pillow can be placed over a compromised PED in the event of a thermal runaway and the Li-ion fire extinguishing media will be released as result of the heat, smothering the burning object, extinguishing the fire and consuming smoke and fumes. However, these methods have disadvantages. Burn bags require handling and timely placement of the overheating or burning device into the burn bag. This poses a serious risk for the operator extinguishing the fire. Blankets are not always suitable as they are often difficult to deploy effectively in hard-to-reach areas. Furthermore, blankets cannot extinguish the fire, which will continue to burn and off-gas under the blanket. The CellBlock PED-Pad is also risky to deploy and requires use of gloves and goggles to protect the operator. In addition, it can be difficult to effectively deploy, for example if the Li-ion fire emergency is between seats or in an overhead compartment and has a limited amount of fire suppressant media.

### SUMMARY OF INVENTION

It is an object of this invention to provide a device and method for safely and effectively suppressing or extinguishing Li-ion battery fires regardless of the origin or location of the fire. It is another object of the invention to provide a portable and easy to use device for safely and effectively delivering free-flowing granular media to a fire or the potential fire. It is another object of the invention to provide a portable and easy to use device capable of safely and effectively delivering free-flowing granular fire suppression media capable of suppressing or extinguishing fires or the potential fires caused by the failure of Li-ion batteries, particularly in confined settings, such as aviation settings.

It has now surprisingly been found that free-flowing granular fire suppression media can be safely and effectively delivered to a fire using the device of the present invention, which comprises a hollow tubular member fitted with an auger, said tubular member having a first opening for supplying free-flowing granular fire suppression media to the auger, and a second opening through which the fire extinguishing media may be applied to the fire or emergent fire. The device of the invention is particularly useful for delivering free-flowing fire suppression media such as expanded glass to Li-ion fires or potential fires, including compromised PEDs and other Li-ion battery containing devices.

### BRIEF DESCRIPTION OF THE DRAWINGS

FIG. 1 is a schematic representation of the device of the invention with two versions of an interchangeable reservoir for holding fire suppressant media.

FIG. 2 is a photograph of a portion of an embodiment of a device according to FIG. 1 showing an electric drive motor attached to the barrel tube and a vertical port tube for attaching a reservoir storage holder for fire suppressant media

FIG. 3 is a photograph of a portion of an embodiment of a device according to FIG. 1 showing the fire suppressant media reservoir.

FIG. 4 is a photograph of a side view of an embodiment of a device according to FIG. 1 showing the fire suppressant media reservoir.

FIG. 5 is a photograph of another side view of an embodiment of a device according to FIG. 1 showing the fire suppressant media reservoir.

FIG. 6 is a photograph of another side view of an embodiment of a device according to FIG. 1 showing the fire suppressant media reservoir.

FIG. 7 is a photograph of a perspective view of an embodiment of a device according to FIG. 1.

FIG. 8 is a rendering of another embodiment of the fire suppressant device of the present invention.

FIG. 9 is a perspective view of another embodiment of the device of the present invention showing a different media reservoir and nozzle configuration.

FIGS. 10(a) and (b) are renderings of a top and side view, respectively of an embodiment of the device of the present invention without the media reservoir and nozzle attached.

FIGS. 11(a) and 11(b) are drawings of the top and cross-sectional side view, respectively of an embodiment of the fire suppressant device of the invention without the media reservoir and nozzle attached. FIG. 11(b) inter alia shows the shows the internal auger and the electrical motor and mechanism for turning the auger.

FIG. 12 depicts a cross-sectional side view of and embodiment of the fire suppressant device of the present invention showing the barrel tube with auger, the attachment for the fire suppressant media reservoir, and electrical motor for turning the auger.

FIG. 13 shows an expanded view of the barrel tube of an embodiment of the fire suppressant device of the present invention showing the barrel tube, auger, attachment for the fire suppressant media reservoir, and the attachment for the electrical motor.

FIG. 14 shows one embodiment of the electrical motor attachment mechanism for connecting the auger to the electrical motor that when activated rotates the auger to expel fire suppressant media.

FIGS. 15(a), (b) and (c) show the configuration of an experimental Li-ion battery arrangement used to model a Li-ion fire emergency. FIG. 15(a) is a top-down schematic of the Li-ion battery cell test configuration showing three thermocouples connected to a data acquisition system, and two heaters connected to the power supplies for overheating the batteries to create a thermal runaway emergency situation; FIG. 15(b) shows the location of the thermocouple probe between Li-ion cells, and FIG. 15(c) shows a comportment containing the test Li-ion battery configuration and the location of the camera relative to the test compartment.

FIG. 16 is a photograph of the Li-ion battery test configuration for a Li-ion battery thermal runaway experiment showing the configuration with an aluminum frame and side insulation boards.

FIG. 17 is a photograph of the Li-ion battery test configuration for a Li-ion battery thermal runaway experiment showing the configuration bound together by a glass cloth tape, thermocouples and heater units with electrical attachments.

FIG. 18 is a photograph of the Li-ion battery test configuration for a Li-ion battery thermal runaway experiment showing the configuration bound together by a glass cloth tape, with aluminum frame and side insulation boards, and connected thermocouples and heaters.

FIG. 19 Is a photograph of the test set-up for the Li-ion battery thermal runaway experiment showing the Li-ion configuration shown in FIG. 18 in container for safely conducting Li-ion battery fire emergency suppression test.

FIGS. 20 and 21 are photographs of fires occurring during Baseline Test 1 as a result of thermal runaway created upon activating the heaters in the test set-up.

FIG. 22 is a graph showing the recorded temperature profiles from the thermocouples during Baseline Test 1. The thermal runaways are marked in the plot. In Baseline Test 1, all the cells were damaged by thermal runaway. Despite the tight fitting of the battery pack inside the aluminum frame, the thermocouple probes were displaced after successive thermal runaways, especially toward the end of the test. The displacement of the thermocouple probes caused a sharp drop in the recorded temperatures, as shown. The maximum temperature was 957° C., recorded at 1326 seconds from the start of the test.

FIG. 23 is a series of photographs taken during the thermal runaway in Baseline Test 1 from time 879 s through time 1381 s.

FIG. 24 is a graph showing the recorded temperature profiles from thermocouples during Baseline Test 2.

FIG. 25 is a photograph of the Li-ion battery test configuration at the conclusion of Baseline Test 2.

FIG. 26 is a graph showing the recorded temperature profiles for Baseline Test 3, in which the power supplies were turned off after the first thermal runaway.

FIG. 27 is a graph showing the recorded temperature profiles for Suppression Test 1.

FIG. 28 is a series of photographs taken during the thermal runaway Suppression Test 1 from time 801 s through time 1210 s. Shows recorded temperature profiles from the thermocouples for Suppression Test 1.

FIGS. 29(a), (b) and (c) show rupturing of Li-ion cell bodies or compression and attachment of the Li-ion cells after application of suppression agent.

FIG. 30 is a graph showing the recorded temperature profiles from thermocouples during Suppression Test 2.

FIG. 31 is a graph showing the recorded temperature profiles from thermocouples during Suppression Test 3.

### DETAILED DESCRIPTION OF THE INVENTION

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention.

The phrase “and/or” as used herein, should be understood to mean “either or both” of the elements so conjoined, i.e., elements that are conjunctively present in some cases and disjunctively present in other cases.

As used herein, “or” should be understood to have the same meaning as defined above for “and/or.” For example, when separating a listing of items, “and/or” or “or” shall be interpreted as being inclusive, i.e., the inclusion of at least one, but also including more than one, of a number of items, and, optionally, additional unlisted items. Only terms clearly indicated to the contrary, such as “only one of” or “exactly one of,” or, when used in the claims, “consisting of,” will refer to the inclusion of exactly one element of a list of elements. In general, the term “or” as used herein shall only be interpreted as indicating exclusive alternatives (i.e., “one or the other but not both”) when preceded by terms of exclusivity, such as “either, “one of,” “only one of,” or “exactly one of.”

The term “about” means a range of values including the specified value, which a person of ordinary skill in the art would consider reasonably similar to the specified value. In embodiments, “about” means within a standard deviation using measurements generally acceptable in the art. In embodiments, “about” means a range extending to +/−10% of the specified value. In embodiments, “about” includes the specified value.

Throughout the description and claims of this specification, the word “comprise” and variations of the word, such as “comprising” and “comprises,” means “including but not limited to,” and is not intended to exclude, for example, other additives, components, integers, or steps.

The term “consisting of” means including, and limited to, whatever follows the phrase “consisting of.” That is, “consisting of” indicates that the listed elements are required or mandatory, and that no other elements may be present.

The term “consisting essentially of” indicates that any elements listed after the phrase are included, and that other elements than those listed may be included provided that those elements do not interfere with or contribute to the activity or action specified in the disclosure for the listed elements.

Free-flowing granular fire suppressant media suitable for use the present invention includes granular materials such as sand, vermiculite, and more preferably glass and mineral aggregates such as silica which when applied to Li-ion fires can smother the fires and/or penetrating battery cells. The term free-flowing granular fire suppressant media refers to any material composed of small, discrete particles of any shape useful for suppressant or extinguishing fires. It can be a fine powder or a grainier material and may be composed of uniformly or non-uniformly shaped and sized particles. The particle size may be from about 0.01 to about 5 mm, preferably from about 0.01 to about 2.5 mm, and most preferably from about 0.3 to about 1.2 mm. It could also be a mixture of different size particles, for example, fine (0.1-0.3 mm), medium (0.3-0.6 mm), coarse (0.6-1.2 mm) and extra course (1.2-2.5 mm). Preferably the free-flowing granular fire suppressant material is a fine powder composed of very fine glass particles. Most preferably the free-flowing granular fire suppressant media is expanded (foamed) glass. This material has been found to be useful in extinguishing, and not only suppressing, Li-ion fires. Examples of expanded glass fire suppressant media include Poraver® Expanded Glass (a lightweight aggregate made from 100% post-consumer recycled glass), produced by Dennert Poraver GMBH, including a material sold under the trade name Extover® as a fire extinguisher, and CellBlock EX® mineral-based media for Extinguishing Li-ion Battery Fires, both of which are incorporated herein by reference. Examples of this media are described in U.S. Pat. Nos. 1,124,703 and 11,124,441, which are incorporated herein by reference.

The device of the present invention comprises a hollow tubular member fitted with an auger, the tubular member having a first opening for supplying free-flowing granular fire extinguishing media to the auger, and a second opening through which the fire extinguishing media may be applied to the fire or emergent fire. The device includes a mechanism for rotating the auger, which is preferably an electric motor, but could also be a mechanical handle for manual operation or other actuating method.

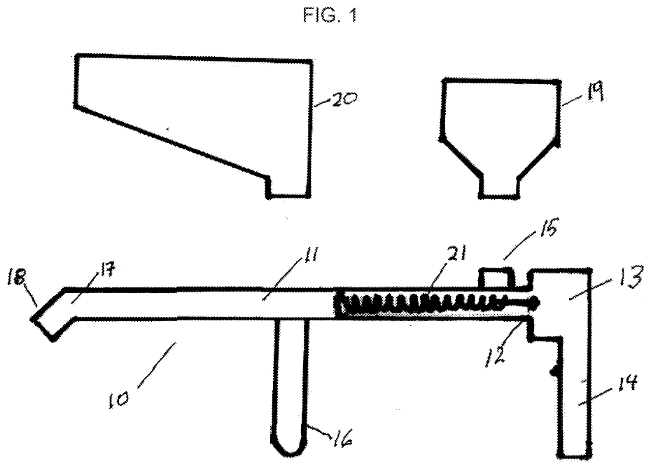

FIG. 1 shows a side view of one embodiment of the free-flowing granular fire suppressant media applicator device (10). The applicator device 10 comprises a hollow barrel or tube (11) with an electric drive motor (13) having a handle (14) attached at one open end (12) and an outlet or nozzle (18) attached at the other open end (17). Attached to the electric drive motor (13) is a shaftless auger (21) that extends inside the hollow barrel or tube (11) towards the open end (17). Part of the hollow tube in FIG. 1 is removed to reveal the auger for purposes of illustration. The auger may include a shaft but is preferably shaftless. The outlet or nozzle (18), preferably rotatable, is shown attached to the open end (17) at an angle to allow application of fire suppressant media. A handle or stand (16) is preferably attached to the hollow barrel or tube (11) to allow manipulation or placement of the device (10) by the operator to enable delivery of the fire suppressant media to the desired location. On the hollow barrel or tube (11) near the open end (12) which attaches to an electric motor connected to the auger shank, is an opening or port (15) through which fire suppressant media may be inputted and to which a media reservoir (19) suitable for containing free-flowing granular fire suppressant media may be attached. Various designs for the media reservoir including (20) can be used with the applicator device (10). The media reservoir may be open or covered and may be in the form of a replaceable cartridge pre-filled with free-flowing fire suppressant media.

The port (15) allows for the free-flowing granular fire suppressant media to drop down from the reservoir (19) onto the auger 21 inside the hollow barrel or tube (11). Switching on the electric motor turns the auger thus moving the media through the hollow barrel or tube (11) towards the open end (17) where it is ejected from the outlet or nozzle (18), preferably rotatable, thereby allowing the delivery of the media in an efficient and timely manner to suppress or extinguish a fire, including a Li-ion battery fire or emergent fire.

The diameter of the hollow barrel or tube (11) can vary in size depending on the type of media used, the preferred rate of delivery of the media, and the preferred distance from the fire. The auger (21) can vary in size depending on the diameter of the hollow barrel or tube (11). The length of the auger is preferably essentially equal to that of the hollow tube but can also be longer or shorter. For free-flowing granular fire suppressant media such as Poraver® Expanded Glass a hollow barrel or tube (11) having a diameter of 1.5 inches and the same size auger, with both being about 24 inches long will allow the media to be distributed at a rate that will work to effectively suppress or extinguish a fire while also allowing the operator to remain a safe distance from the fire or compromised device. However, the length and diameter of the hollow barrel and auger may be longer or shorter as required by the type of contemplated emergency.

The electric drive motor (13) that drives the auger can have a variable rate of revolutions per minute, thereby allowing for different rates for ejection of the extinguishing media.

The device (10) can be made using any suitable material, including polyvinylchloride (PVC) or a lightweight metal. The electric drive motor can have a rechargeable battery as a power source.

The port (15) may be designed for quick attachment and release of the fire suppressant media reservoir (19), thereby allowing for additional media to be applied to the desired location as necessary.

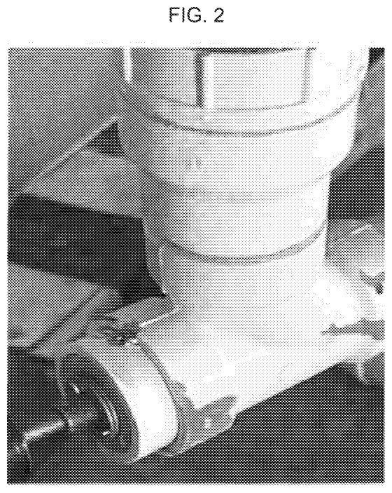

FIG. 2 shows an embodiment with an electric drive motor (13) attached to the barrel tube (11) and a vertical port tube (15) for attaching a reservoir storage holder (19) for fire suppressant media.

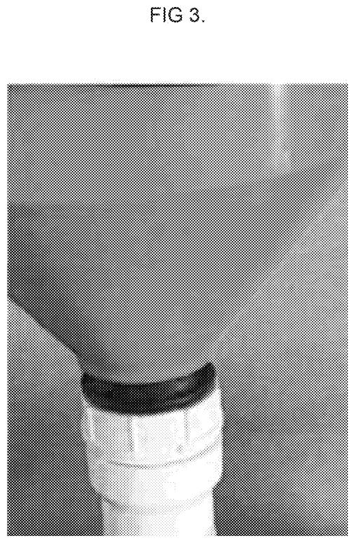

FIG. 3. shows an embodiment with the fire suppressant media reservoir attached to the vertical port tube (15).

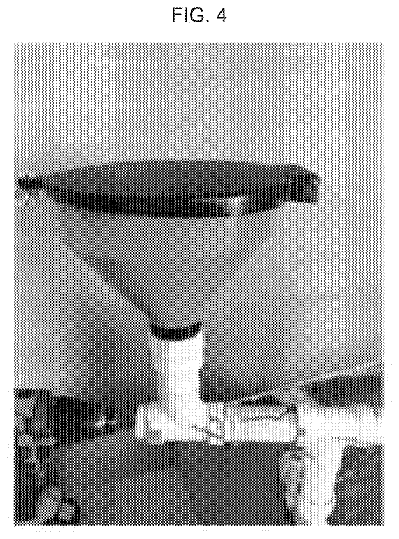

FIG. 4. shows an embodiment with the electric motor (13), the container (19) for the fire suppressant material attached to the vertical port tube (15) and the hollow tube (11) of the fire suppressant media applicator device (19 or 20).

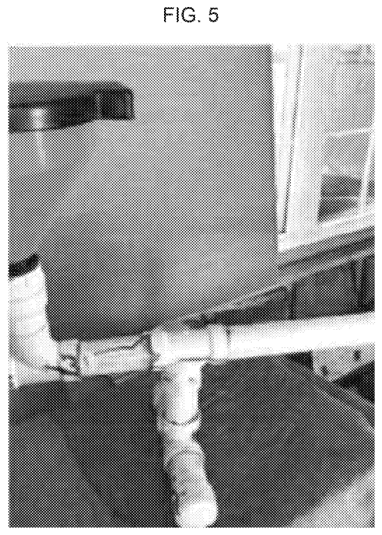

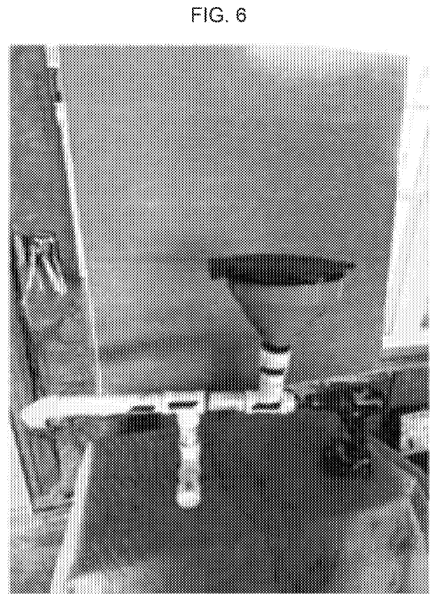

FIG. 5 shows a picture of free-flowing granular fire suppressant media applicator device (10) with the handle or stand (16).

FIG. 6 shows a picture of free-flowing granular fire suppressant media applicator device (10) with hollow barrel (11), the handle or stand (16) and the electric motor (13) with handle (14). Also shown is a rotatable end on the hollow barrel (11). The rotatable end (18) is optional.

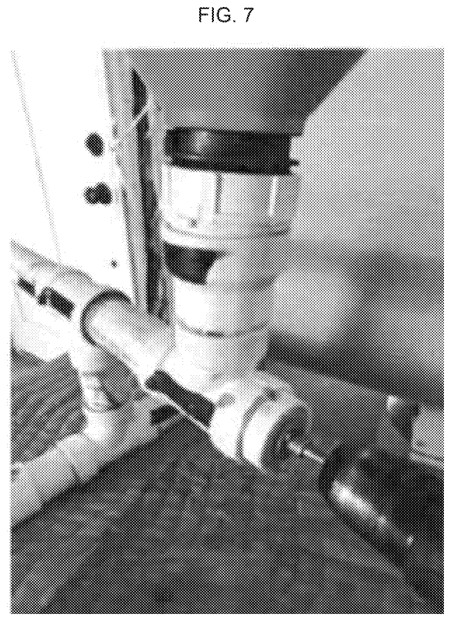

FIG. 7. shows an example of attachment of the electric motor to the hollow barrel (11).

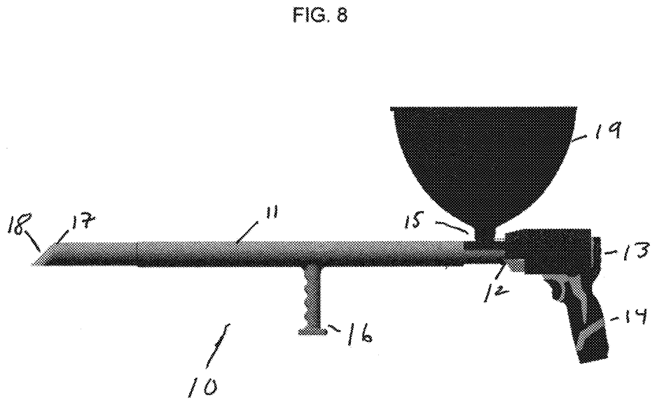

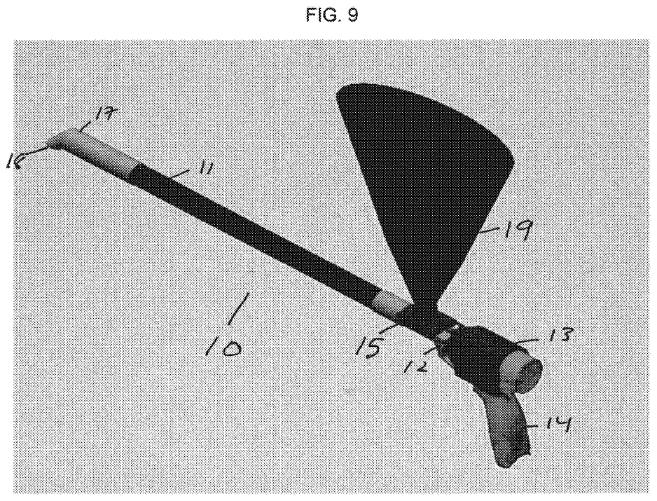

FIGS. 8 and 9 show additional embodiments of the device of the present invention. The outlet or nozzle (17) may be detachable and/or rotatable and the end (18) may have a variety of shapes. The hollow barrel (11) is preferably made of fire-resistant material, preferably carbon fiber or other suitable material. Similarly, the auger (21), not shown, is made of fire-resistant material, preferably low-carbon steel. The diameter of the hollow barrel or tube is from about 0.5 to 5 inches, preferably about 1 to 3 inches and most preferably about 1.5 inches. The flow rate may be adjustable by adjusting the speed of the actuator.

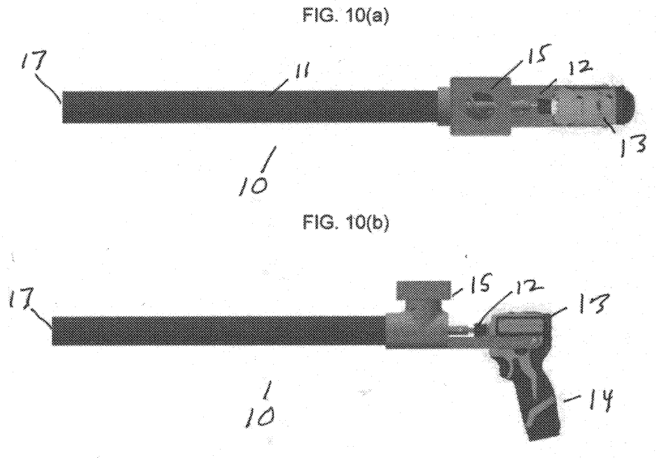

FIG. 10(a) shows a top view of the free-flowing granular fire suppressant media applicator device (10) with outlet (17), hollow barrel (11), and attachment fixture (15) for the fire suppressant media reservoir (19 or 20). Also shown is a connection mechanism (12) for the electrical motor (13).

FIG. 10(b) shows a side view of free-flowing granular fire suppressant media applicator device (10) with outlet (17), hollow barrel (11), attachment fixture (15) for the fire suppressant media reservoir (19 or 20). Also shown is a connection mechanism (12) for the electrical motor (13) and the handle (14).

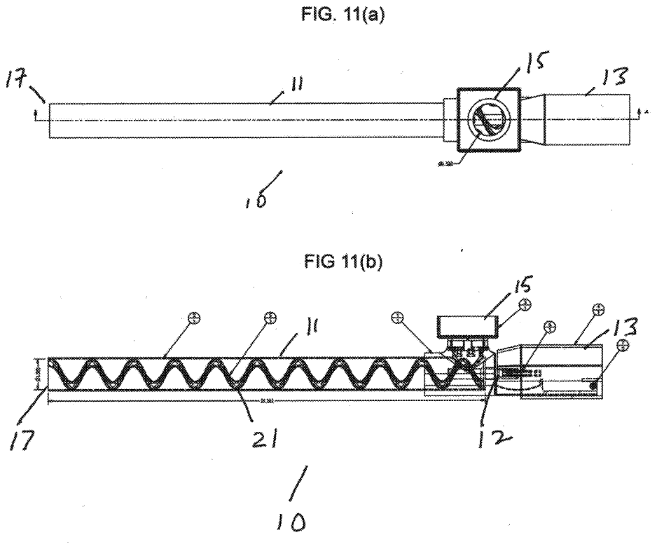

FIG. 11(a) shows an embodiment of the top schematic view free-flowing granular fire suppressant media applicator device (10) with outlet (17), hollow barrel (11), and attachment fixture (15) for a fire suppressant media reservoir (19 or 20 or suitable variation). Also shown is the electrical motor (13).

FIG. 11(b) shows a cross-sectional side view of an embodiment of the fire suppressant device of the invention without the media reservoir and nozzle attached, as well as the internal auger (21) and the electrical motor (13) and mechanism for connecting the electrical motor to the auger to actuate rotation of the auger (12).

FIG. 12 shows a cross-sectional view of the free-flowing granular fire suppressant media applicator device (10) with the internal auger portions inside the hollow barrel (11). Also shown is the attachment (15) for a fire suppressant media reservoir (19 or 20 or suitable variation capable of holding the fire suppressant material). Also shown is the attachment mechanism (12) for the electrical motor (13).

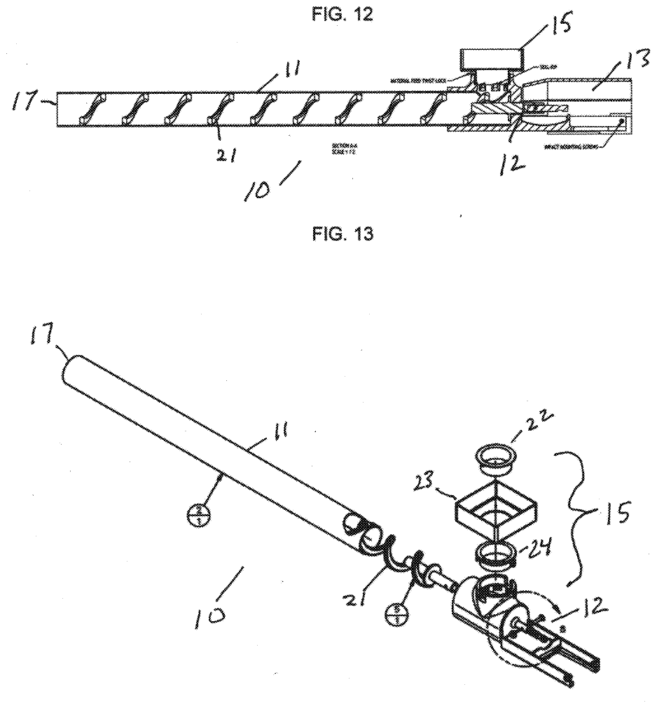

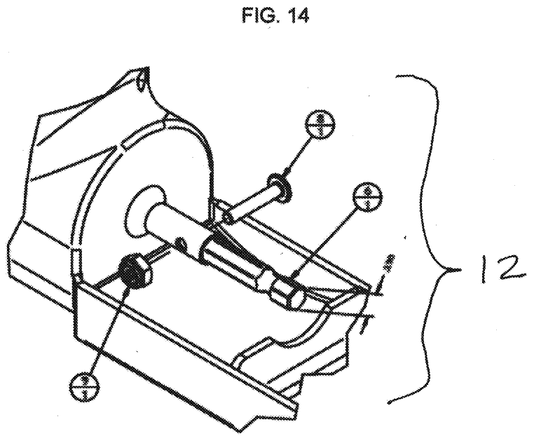

FIG. 13 shows an exploded view of free-flowing granular fire suppressant media applicator device (10) with the internal auger (21) (optionally shaftless) portions inside the hollow barrel (11). Also shown is the attachment mechanism for the electrical motor (12). Other suitable attachment mechanisms may also be used that allow for attachment of an electrical motor (13) to turn auger (21). FIG. 13 also shows an expanded view of the attachment mechanism (15) with ports (22-24) that can be used for attaching the fire suppressant media reservoir (19 or 20 or suitable variation capable of holding the fire suppressant material) to the port outlet in the hollow barrel for supplying fire suppressant media to the device.

FIG. 14 shows an example of a possible connection mechanism (12) to connect an electrical motor (13) to actuate rotation of the auger in the free-flowing granular fire suppressant media applicator device (10).

The detailed description of one or more embodiments of the disclosed device and method are presented herein by way of exemplification of the invention and not limited with reference to the Figures. In addition, the utility of this device is not limited to fires or emergencies resulting from the failure of Li-ion batteries and as exemplified below may be used effectively to extinguish non-Li-ion battery fires.

### Examples

Example 1. As an initial test of the fire suppressant or extinguishing capabilities of the free-flowing granular fire suppressant media applicator device, the device was loaded with Poraver® Expanded Glass and the operator of the device was able to rapidly and efficiently extinguish a non-Li-ion test fire by aiming the applicator or nozzle end of the device over the fire and applying the extinguishing media.

Example 2. A PED is subjected to conditions causing Li-ion battery failure. The device of the invention loaded with Poraver® Expanded Glass is used to apply this free-flowing granular fire suppressant media from a safe distance to the device thus extinguishing the fire.

Example 3. Preliminary Lithium-Ion Battery Fire Suppression Assessment. Suppression of Lithium-ion Battery fire was assessed using six lithium-ion (Li-ion) battery thermal runaway tests: three baseline tests (no suppression agent applied) and three additional tests in which a suppression agent was applied using the device of the present invention upon thermal runway. The start and location of a the application, and number of times and amount of fire suppression media applied was variable from from test to test. In each test, twelve Molicel P28A 18650 battery cells were arranged in a packed configuration (with cells not electrically connected to each other), in four rows, with each row containing three cells. All of the cells were at 100% state of charge (SOC) for each test. In each test, one of the cells (mid-front cell) was heated using two individually controlled, constant power cartridge heaters to induce thermal runaway. The temperature was recorded as a function of time at three distinct locations in the battery assembly. Applying the suppression agent caused cell rupture during thermal runaway, which was not observed in the baseline tests. The mass loss per failed cell was significantly higher when using the suppression agent during testing compared to the baseline tests.

### Materials

Brand new Li-ion Molicel P28A 18650 cells (INR-18560-P28) were used in all tests. The details about these cells can be found in Table 1. This information was obtained from https://www.18650batterystore.com/products/molicelp28a?srstid=AfmBOopQnKe7Y5u5Q D-e9hn79EUPOLfkrsdj4SGXiHyTb5b20ilZCrDs.

TABLE 1
Summary of the Technical Specifications of the Li-ion Cells used.

| Manufacturer | Molicel | |
|---|---|---|
| Model | P28A | |
| Size | 18650 | |
| Nominal Capacity | 2800 | mAh |
| Continuous Discharge Rating (max) | 35 | A |
| Nominal Voltage | 3.6 | V |
| Maximum Voltage | 4.2 | V |
| Discharge cut-off Voltage | 2.5 | V |
| Approximate Dimensions | 18.50 mm × 65.15 mm | |
| Approximate Weight | 45.18 | g |

The cells were fully charged (100% SOC) with open circuit voltage of 4.1 V and the plastic covering was removed before preparing the test setup. The initial mass of each cell after removing the plastic cover was 44.7±0.1 g.

### Testing Setup

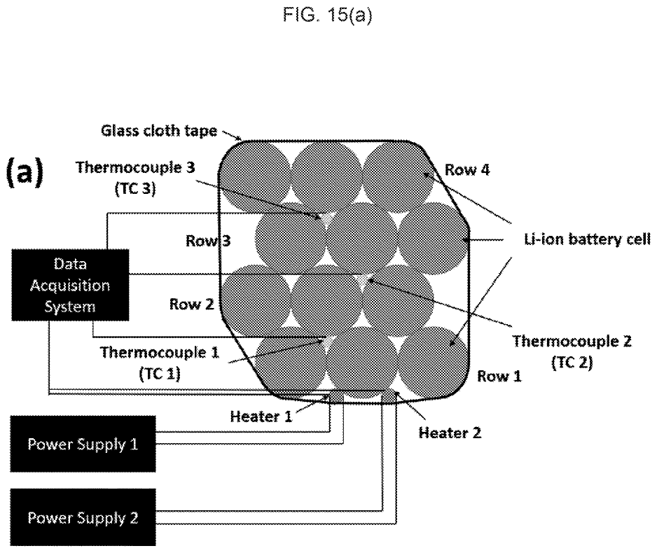

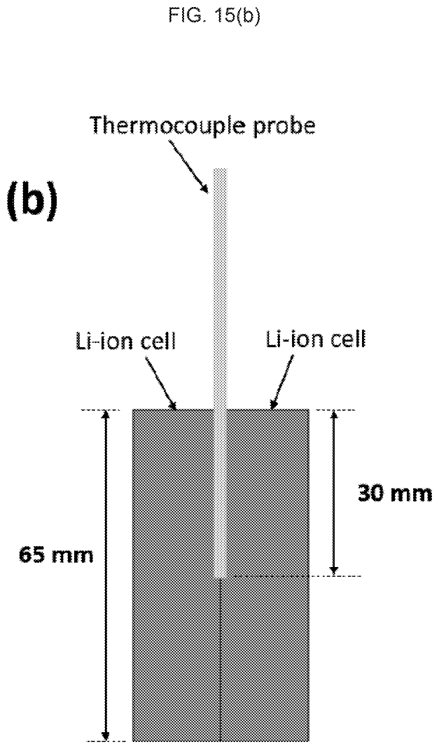

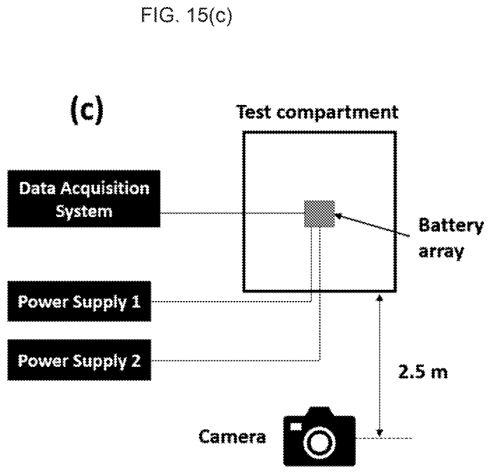

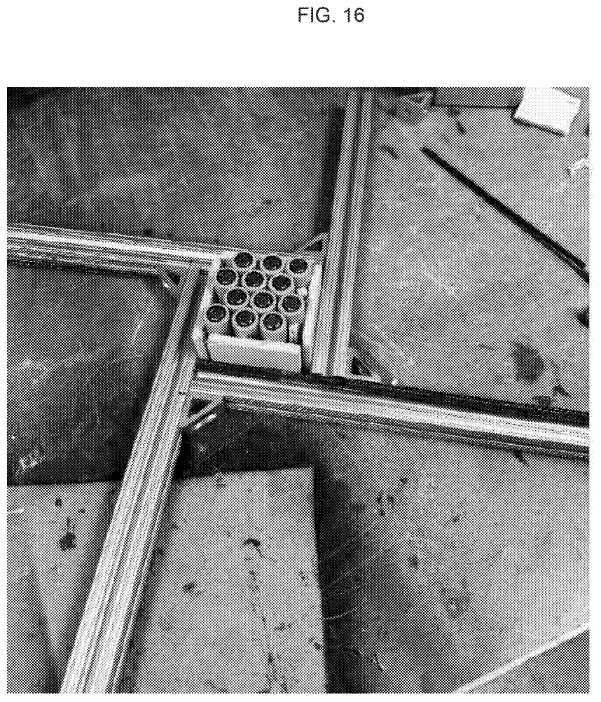

Twelve Li-ion battery cells were used for each test. The cells were packed in a staggered configuration using high-temperature glass cloth tape, as shown in FIGS. 15(a)-(c). By wrapping the sides of the battery array with glass tape, the cells were tightly packed next to each other. Three K-type thermocouple probes were then inserted about 30 mm deep into the empty spaces formed by three adjacent cells between the rows, as shown in FIGS. 15(a)-(c) and 16. During this packing procedure, special care was taken to ensure that the cells were in direct contact with one another and that the thermocouple probes were tightly fitted into the gaps to ensure good thermal contact with the cell surfaces.

To initiate thermal runaway, two cartridge heaters, COMSTAT MCH1-228, with an internal type-K thermocouple were attached to a cell located in the middle of row 1 of the battery array, as shown in FIG. 15. The heaters were attached to the cell using glass cloth tape. Each heater was connected to a separate power supply (BK Precision 1672 and BK Precision 1685B). The voltage and current outputs of the power supplies were monitored throughout the tests and remained approximately constant at 15.8 V and 1.10 A (17.38 W) for the BK Precision 1672, and 15.0 V and 1.16 A (17.40 W) for the BK Precision 1685B.

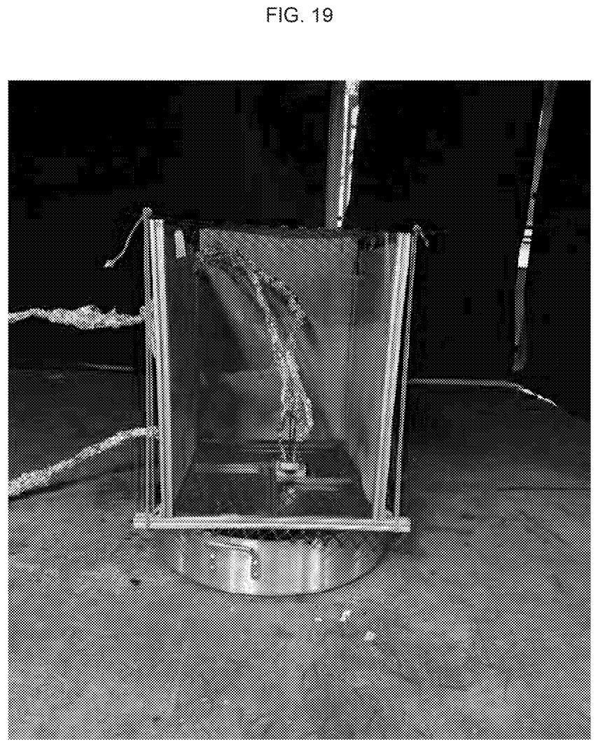

To safely conduct the test, a compartment was constructed out of 80-20 aluminum extrusions to contain the battery arrays and to restrict most of the particles ejected during thermal runaway. The compartment was enclosed using insulation boards as side walls and a mesh ceiling, as shown in FIGS. 15(c) and 19.

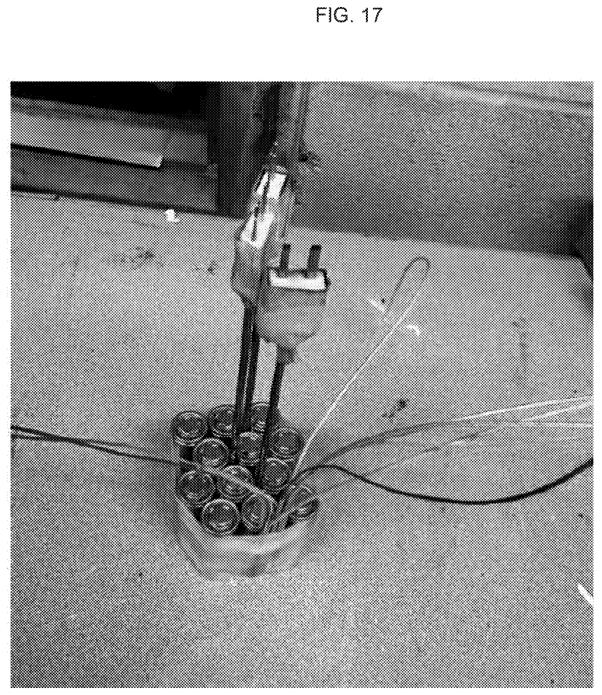

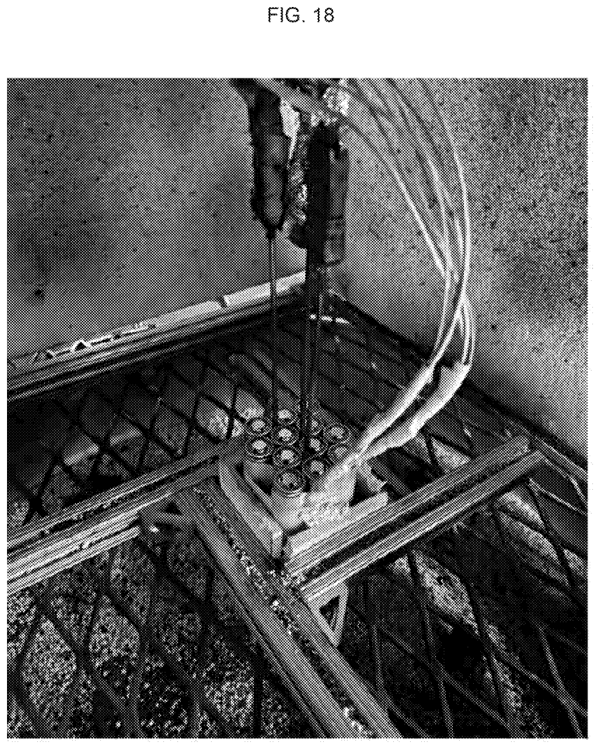

A Sony HDR-CX900 camera was place in distance of 2.5 m from the compartment to record the tests as shown in FIG. 15(a)-(c). To record cell temperatures during testing, three ungrounded K-type thermocouples (0.125-in. probe diameter, 6-in. probe length, 304 stainless steel sheath; Omega model HKMQSS-125U-6), along with the thermocouples embedded in the heaters, were connected to an NI-9210 thermocouple input module. Temperature data were recorded at a frequency of 3 Hz. One channel was used for the two heater thermocouples to obtain the average heater temperature. To minimize heat conduction from the cells to the 80-20 aluminum frame and the bottom mesh, small pieces of insulation board were installed, as shown in FIGS. 16-19. To collect debris and residues ejected from the battery cells during thermal runaway and suppression agent, a tray was placed beneath the compartment. A mesh plate above the tray supported the compartment while allowing access to the tray interior.

Granular suppression media (Poraver® Expanded Glass) was applied using the device of the present invention. In Suppression Test 1, the suppression agent was applied from the ceiling of the compartment, whereas in Suppression Tests 2 and 3 it was applied through an opening in the side wall of the compartment. In Suppression Test 1 the fire suppression media was applied using a device having a smaller barrel, than that used in to apply fire suppression media in Tests 2 and 3. Because these were preliminary tests, the amount of suppression media, the number of applications, and the timing of its application, and the flow rate were variable from test to test.

### Testing Procedure

Table 2 presents the similar conditions for different conducted tests:

TABLE 2
Groups of Tests with Similar Testing Conditions.

| Group I of tests | Group II of tests | Group III of tests |
|---|---|---|
| with similar | with similar | with similar |
| testing condition | testing condition | testing condition |
| Baseline Test 1 | Baseline Test 3 | Suppression Test 3 |
| Baseline Test 2 | Suppression Test 2 | |
| Suppression Test 1 | | |

summary of the testing procedure is given below:
1—The mass and open-circuit voltage of the battery cells were recorded before packing the cells.
2—Two cartridge heaters were attached to one of the cells using high-temperature glass tape.
3—The cells were tightly packed in a staggered arrangement by wrapping them with high-temperature glass tape. The cell with two heaters was placed in the middle of row 1.
4—The thermocouple probes were tightly fitted into the empty spaces created by adjacent three cells at different rows.
5—The prepared testing container was placed on a tray containing a mesh plate.
6—The prepared battery pack was placed inside the aluminum frame.
7—The battery pack was isolated from the aluminum frame and bottom mesh using small pieces of insulation board.
8—The thermocouple wires were connected to the data acquisition system.
9—The heater wires were connected to the power supplies.
10—The wires were covered with aluminum foil to protect them from battery fire during testing.
11—The test container was covered with a mesh from the top. The mesh was connected to the bottom mesh below the container using ropes.
12—The camera started recording together with timer.
13—Temperature data acquisition was started and the corresponding time was recorded using the timer.
14—The power supplies were turned on and the corresponding time was recorded using the timer (corresponding to time zero of the test, t=0).

The subsequent steps differed among the tests and are briefly described as follows:

### Baseline Test 1, Baseline Test 2:

The power sources were kept on until the end of the test.

### Suppression Test 1:

15. The suppression agent was applied after observing the first thermal runaway. The timing of the suppression agent application was extracted from video recordings and is reported in the Results section.

The power sources were kept on until the end of the test.

### Baseline Test 3:

15. The power supplies were turned off after the occurrence of the first thermal runaway.

### Suppression Test 2:

16. The power supplies were turned off after the occurrence of the first thermal runaway.
18. The suppression agent was applied after observing the first thermal runaway. The timing of the suppression agent application was extracted from video recordings and is reported in the Results section.

### Suppression Test 3

15. The power supplies were turned off after venting started from one of the cells.
16. The power supplies were turned on again after the temperature of the cells dropped below 100° C. without the occurrence of thermal runaway.
17. The power supplies were turned off after the occurrence of the first thermal runaway.
18. The suppression agent was applied after observing the first thermal runaway. The timing of the suppression agent application was extracted from video recordings and is reported in the Results section.

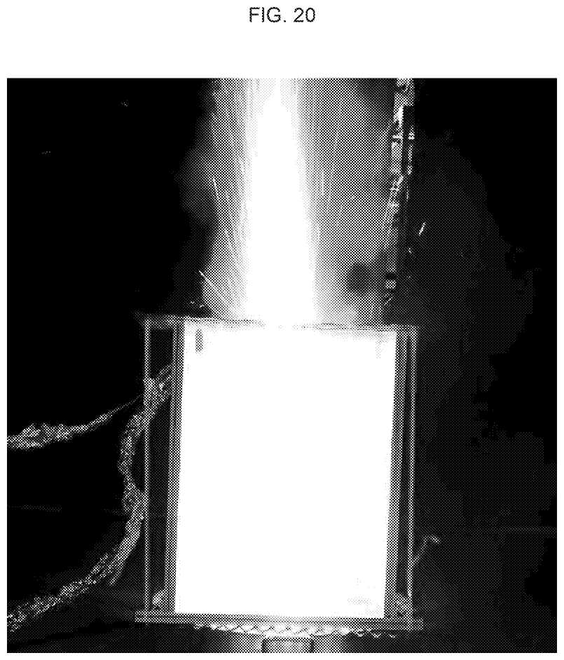

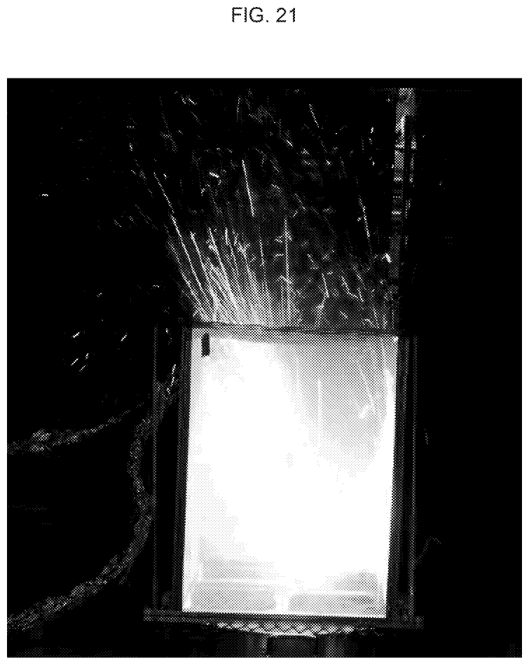

The tests were continued until no further thermal runaway occurred and the cell temperatures dropped below 100° C. Throughout this report, “thermal runaway” refers to the moment when hot, glowing particles are ejected from the cells, creating a fire, as shown in FIGS. 20-21.

### Results

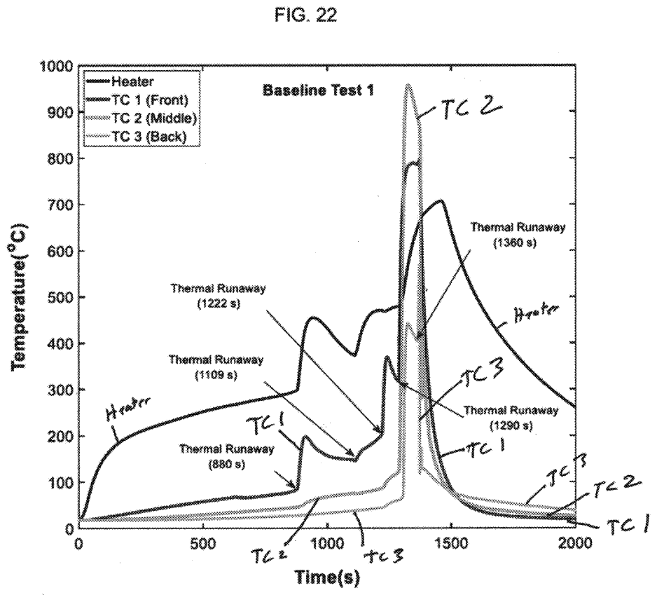

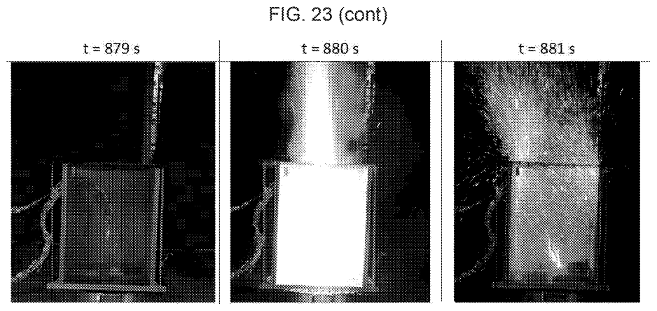

The recorded temperature profiles from the thermocouples for Baseline Test 1 are shown in FIG. 22. The thermal runaways are marked in the plot. In Baseline Test 1, all the cells were damaged by thermal runaway. Despite the tight fitting of the battery pack inside the aluminum frame, the thermocouple probes were displaced after successive thermal runaways, especially toward the end of the test. The displacement of the thermocouple probes caused a sharp drop in the recorded temperatures, as shown in FIG. 22. The maximum temperature was 957° C., recorded at 1326 seconds from the start of the test. The onset of a sharp rise in temperature, measured by TC 3, was recorded at 1306 seconds from the start of the tests.

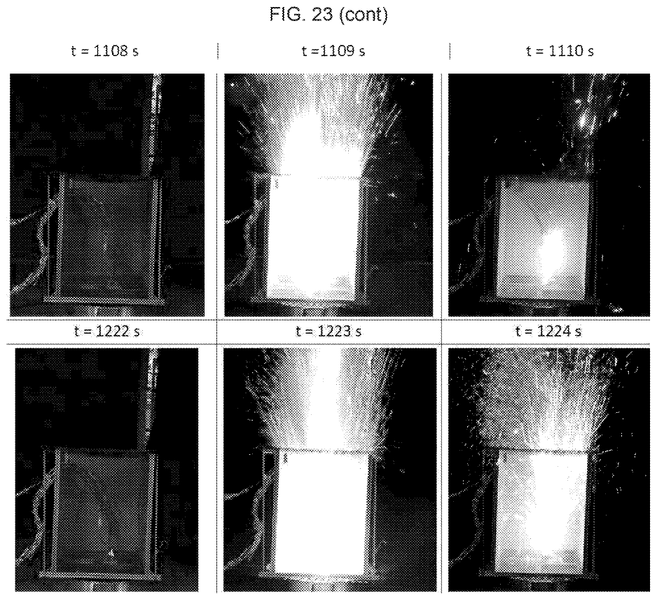

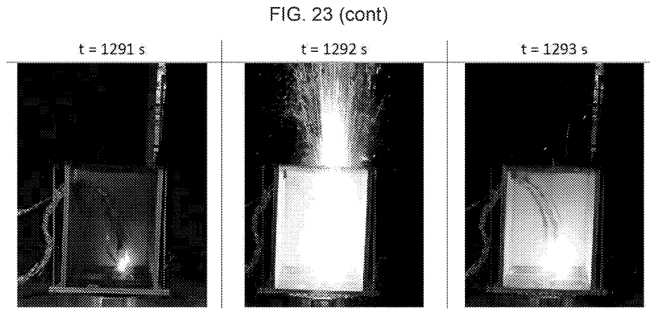

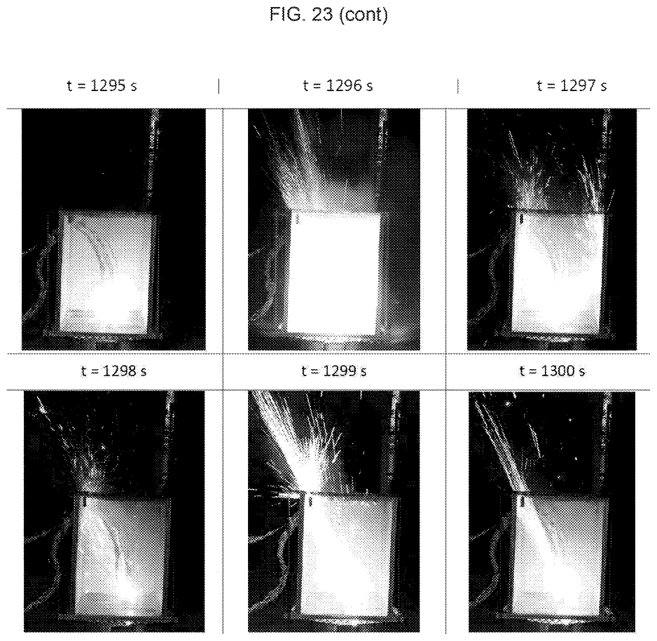

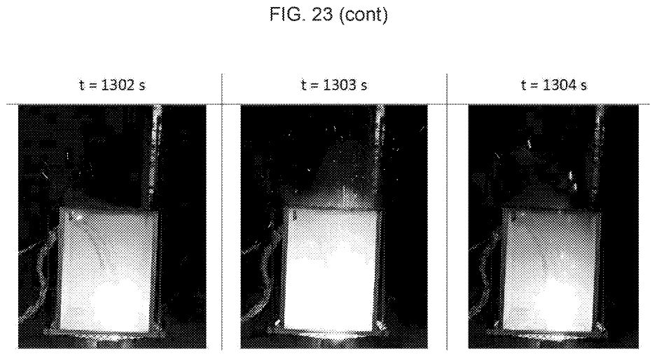

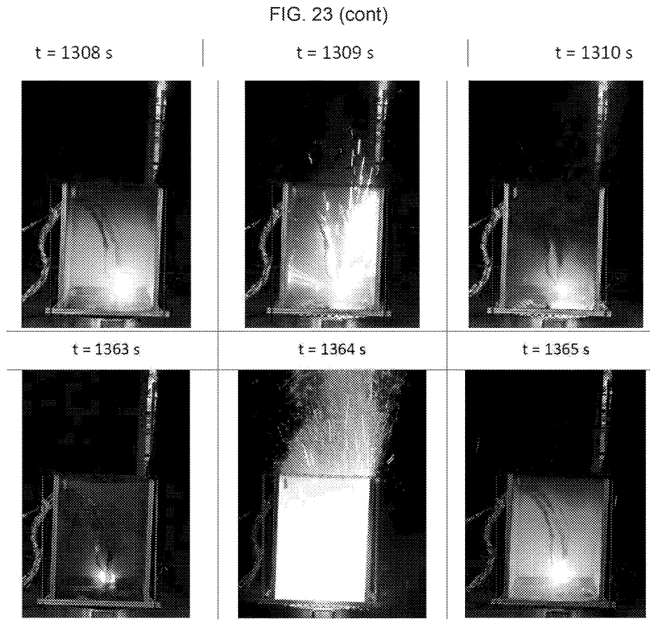

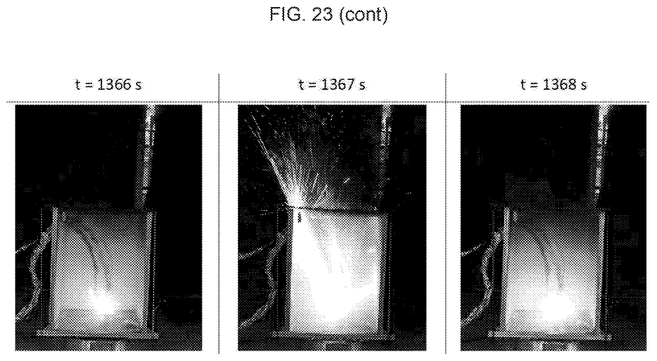

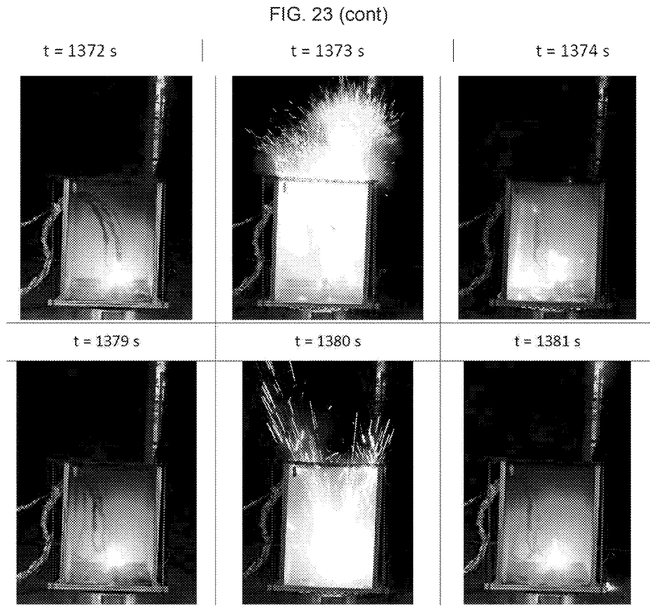

The moments of Li-ion cells' thermal runaway in Baseline Test 1 are shown in FIG. 23. All twelve cells in Baseline Test 1 failed during thermal runaway. Ejecting the glowing hot particle from each cell happened in 1 second and after that a small flame formed above the cells.

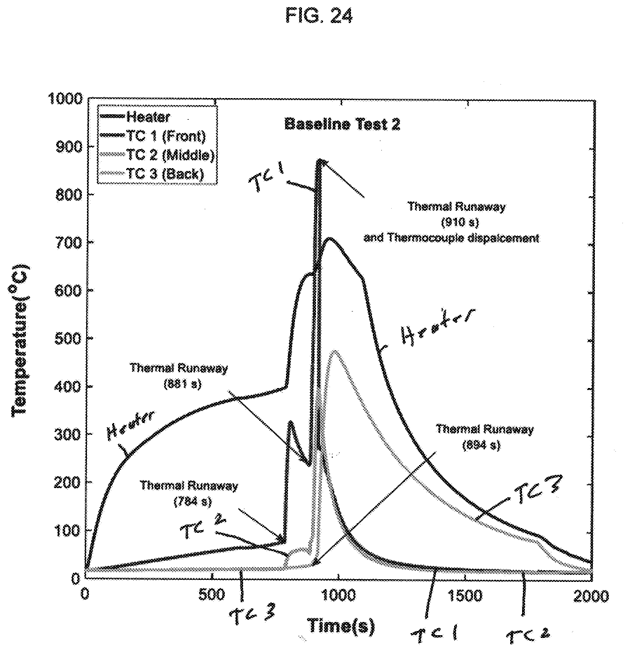

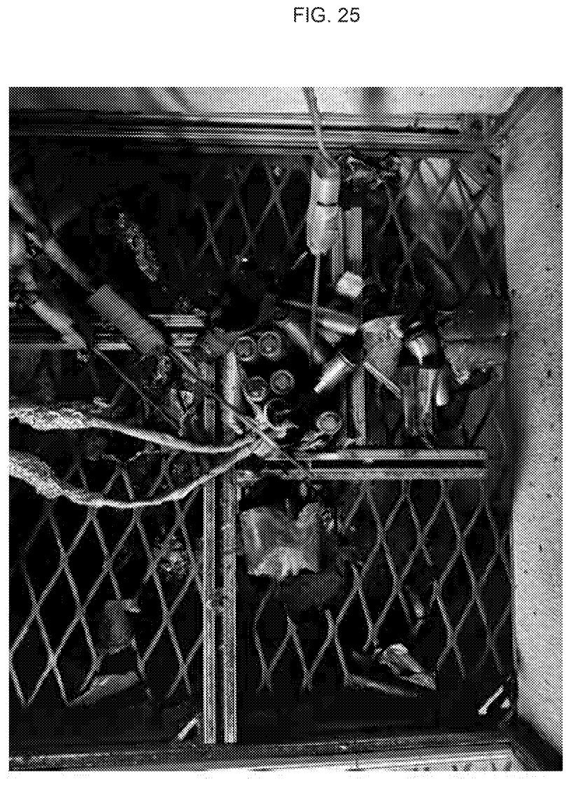

The recorded temperature profiles for Baseline Test 2 are shown in FIG. 6. The testing procedure for Baseline Test 2 was similar to that of Baseline Test 1. The TC 1 and TC 2 thermocouple probes were displaced, resulting in a sharp temperature drop, as shown in FIG. 24. The maximum recorded temperature was 873° C., measured at 912 seconds from the start of the test. The onset of a sharp rise in temperature, measured by TC 3, was recorded at 918 seconds from the start of the tests.

During the sixth thermal runaway, the battery cells were thrown out of the aluminum frame, losing contact with the back-row cells (rows 3 and 4) and leaving six cells unaffected by thermal runaway at the end of the test, as shown in FIG. 25.

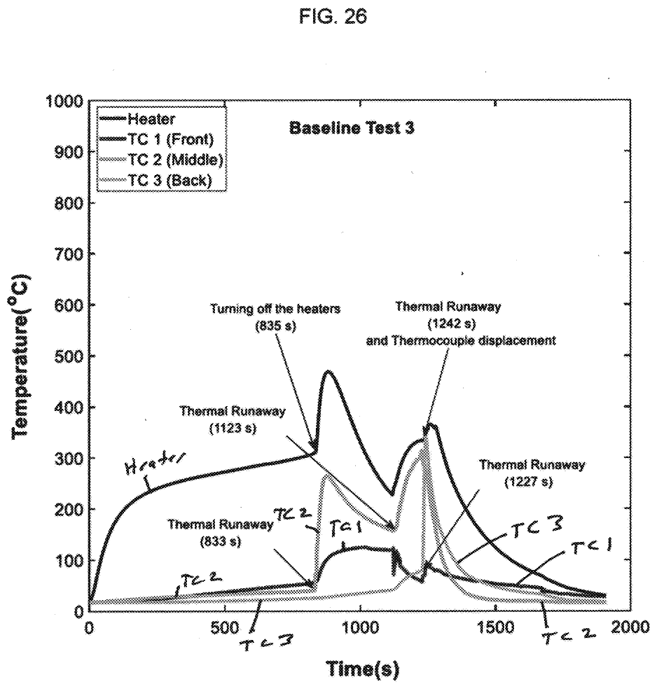

The recorded temperature profiles for Baseline Test 3 are shown in FIG. 26. In Baseline Test 3, the power supplies were turned off after the first thermal runaway, as marked in FIG. 26. A displacement and deformation occurred in the thermocouple placed between rows 1 and 2 (TC 1 (Front) in FIG. 26), probably affecting the recorded temperatures. Similar to the previous Baseline tests, after the sixth thermal runaway, all thermocouples were displaced, causing a sharp drop in the recorded temperatures. The maximum recorded temperature was 341° C., measured at 1243 seconds from the start of the test, during the sixth thermal runaway. Inspection of the cells at the end of the test showed three cells remained unaffected by thermal runaway. The onset of a sharp rise in temperature, measured by TC 3, was recorded at 1232 seconds from the start of the tests.

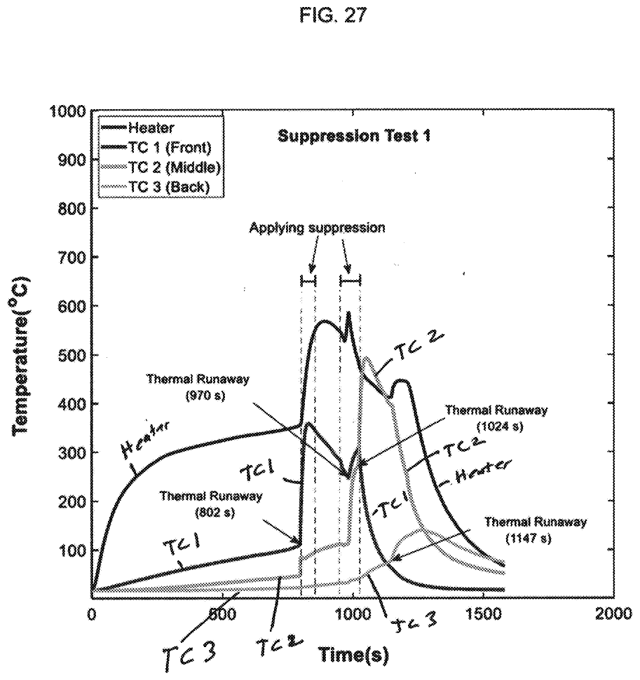

The recorded temperature profiles for Suppression Test 1 are shown in FIG. 27. The testing procedure for Suppression Test 1 was similar to that of Baseline Tests 1 and 2. The moments when the suppression agent was applied over the battery cells were extracted from the video recordings and are marked in the plot. The maximum recorded temperature was 493° C., measured at 1051 seconds from the start of the test, during the third thermal runaway. Inspection of the cells at the end of the test showed that five cells (in rows 3 and 4) remained unaffected by thermal runaway. The onset of a sharp rise in temperature, measured by TC 3, was recorded at 1147 seconds from the start of the tests.

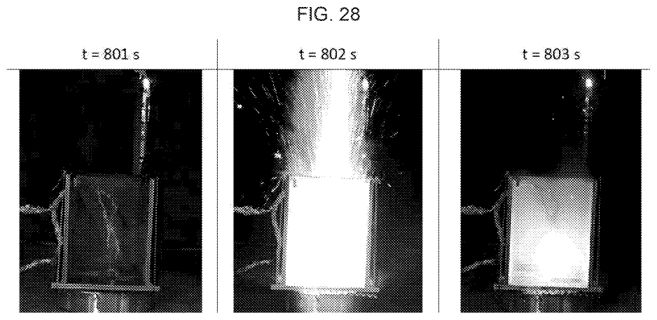

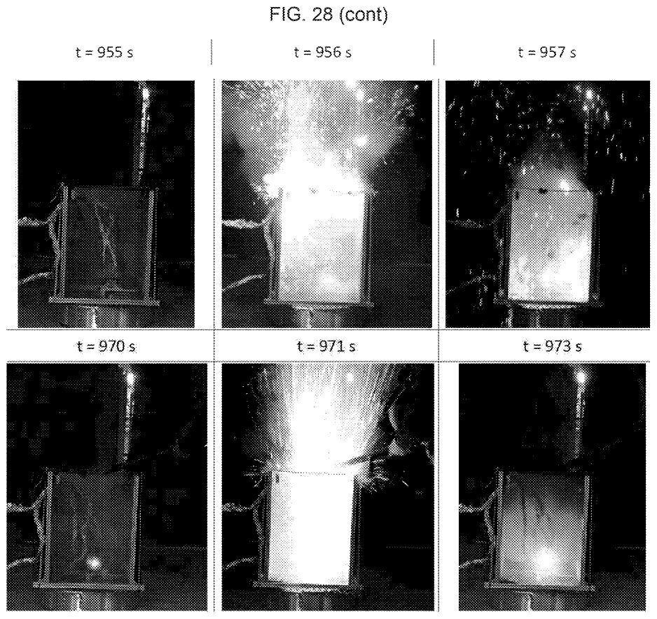

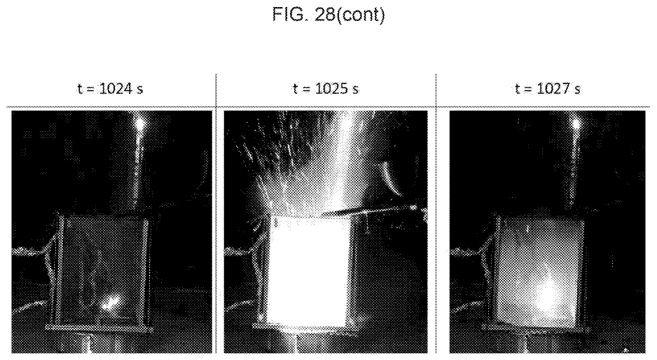

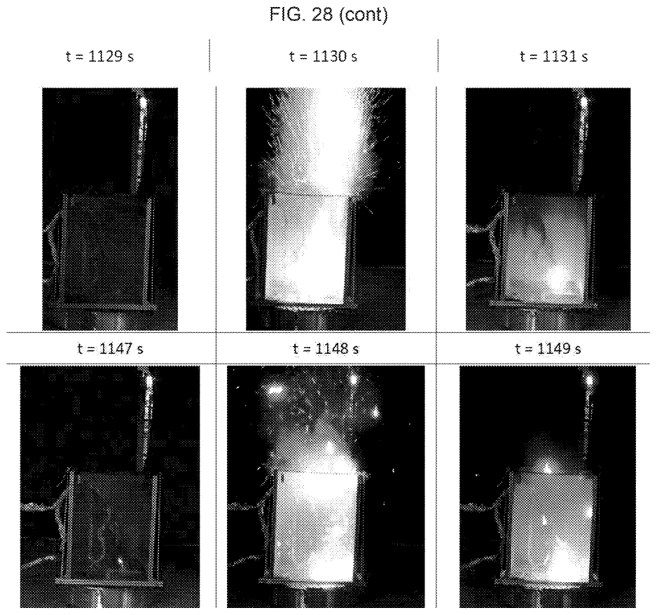

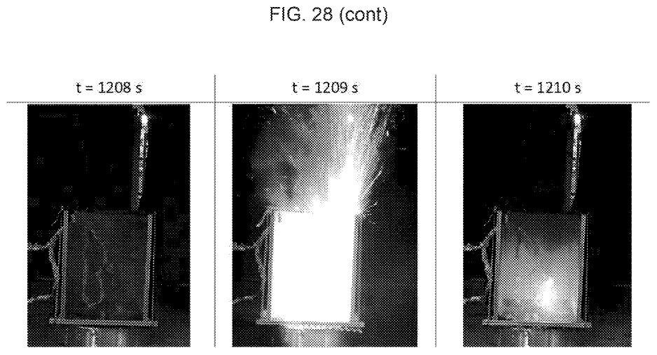

To compare with Baseline Test 1, the moments of Li-ion cells' thermal runaways in Suppression Test 1 have been presented in FIG. 28. The suppression agent was applied after occurrence of the first thermal runaway. Despite applying the suppression agent, in Suppression Test 1, the second thermal runaway happened significantly in shorter time after first thermal runaway with more severe cell failure (causing cell rupture) compared to the Baseline Test 1.

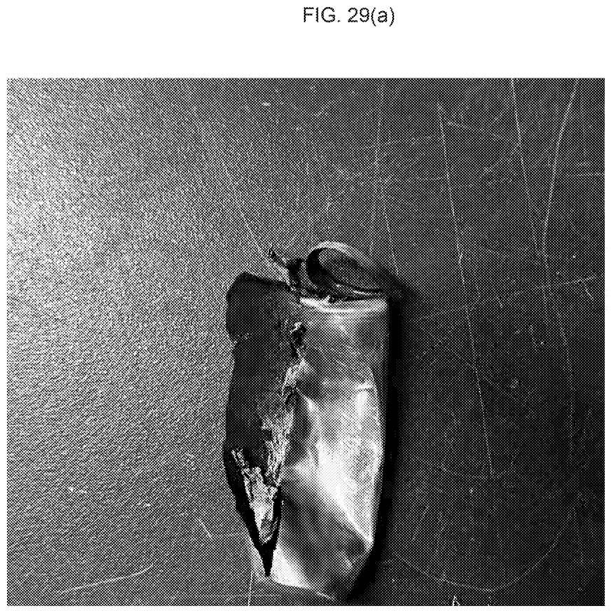

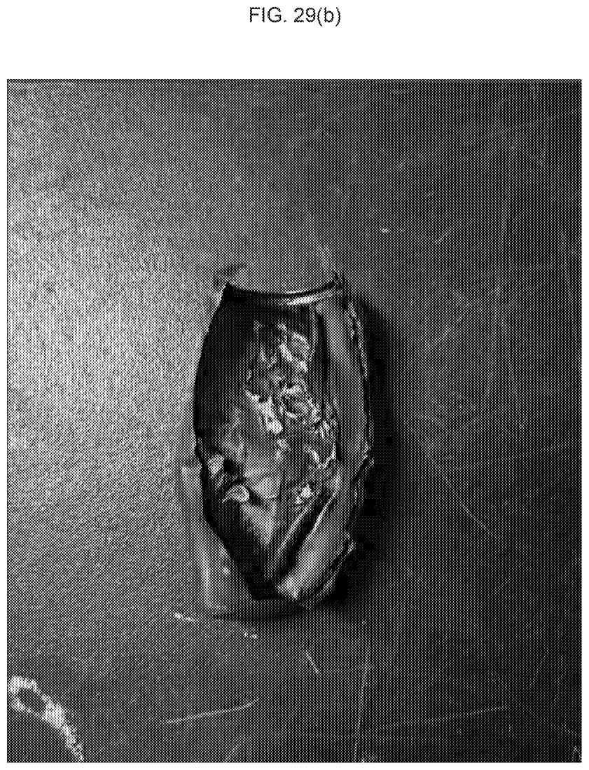

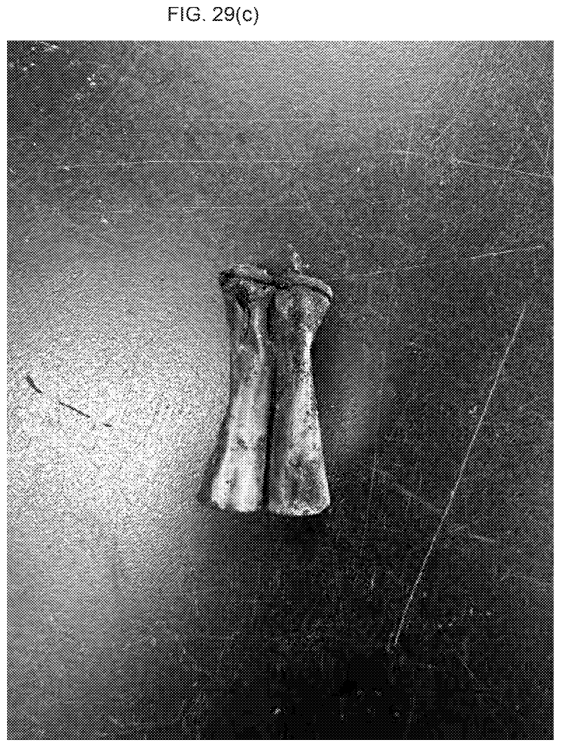

Applying the suppression agent caused rupturing of cell bodies or compression and attachment of the cells, as shown in FIG. 29. The mass loss of ruptured cells was significantly higher (65% to 85% of the initial cell mass) than that observed in the Baseline Tests (20% to 40% of the initial cell mass). FIG. 29(a)—Left-top and (b) right-top: ruptured cell bodies; bottom (c): pressed and attached cells in Suppression Test 1.

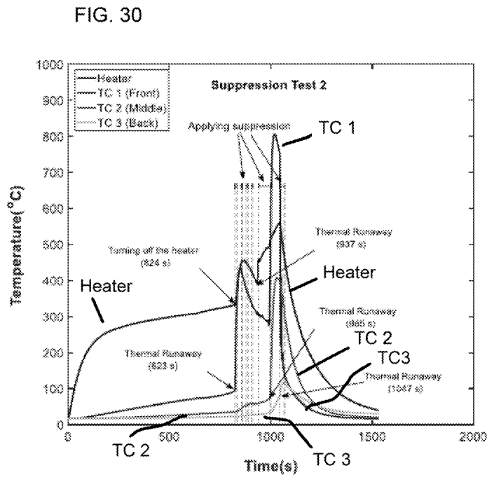

The recorded temperature profiles for Suppression Test 2 are shown in FIG. 30. The testing procedure for Suppression Test 2 was similar to that of Baseline Test 3 (with the power supplies turned off after observing the first thermal runaway). The moments when the suppression agent was applied over the battery cells were extracted from the video recordings and are marked in the plot. The maximum recorded temperature was 806° C., measured at 1019 seconds from the start of the test, during the third thermal runaway. Inspection of the cells at the end of the test showed that five cells (in rows 3 and 4) remained unaffected by thermal runaway. The onset of a sharp rise in temperature, measured by TC 3, was recorded at 1047 seconds from the start of the tests.

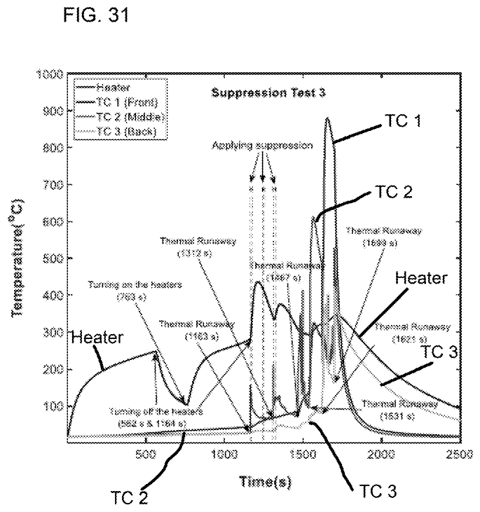

The recorded temperature profiles for Suppression Test 3 are shown in FIG. 31. The testing procedure for Suppression Test 3 was not similar to any of the Baseline Tests, as the power supplies were turned off after the first venting from one of the cells, causing a time shift in the recorded peak temperatures, as shown in FIG. 13. The moments when the suppression agent was applied over the battery cells were extracted from the video recordings and are marked in the plot. The maximum recorded temperature was 880° C., measured at 1655 seconds from the start of the test. Thermal runaway occurred in all the cells. The onset of a sharp rise in temperature, measured by TC 3, was recorded at 1621 seconds from the start of the tests.

The summary of the measured parameters at different tests are given in Table 3.

TABLE 3
Summary of the measured parameters for different tests.

| | | | Number cell | | | Time of | | Onset of |
|---|---|---|---|---|---|---|---|---|
| | | Time to | that did not | Initial | Total | the first | | sharp |
| | Maximum | maximum | undergo | mass of | mass | thermal | Time of the | temperature |
| | temperature | temperature | thermal | the cells | loss | runaway | last thermal | rise |
| Test | (° C.) | (s) | runaway | (g) | (g) | (s) | runaway (s) | in TC 3 (s) |
| Baseline | 957 | 1326 | 0 | 536 | 166 ± 17 | 880 | 1380 | 1306 |
| Test 1 | | | | | | | | |
| Baseline | 873 | 912 | 6 | 536 | 90 ± 9 | 784 | 917 | 918 |
| Test 2 | | | | | | | | |
| Baseline | 341 | 1243 | 3 | 536 | 112 ± 11 | 833 | 1276 | 1232 |
| Test 3 | | | | | | | | |
| Suppression | 493 | 1051 | 5 | 536 | 175 ± 18 | 802 | 1209 | 1147 |
| Test 1 | | | | | | | | |
| Suppression | 806 | 1019 | 5 | 536 | 208 ± 21 | 823 | 1053 | 1047 |
| Test 2 | | | | | | | | |
| Suppression | 880 | 1655 | 0 | 536 | 307 ± 31 | 1163 | 1699 | 1621 |
| Test 3 | | | | | | | | |

From the data and visual assessments it was concluded that the device showed great promise and would be effective in suppressing and/or extinguishing Li-ion fires.

1. A fire suppressant device comprising a hollow tubular member fitted with an auger, said tubular member having a first opening at one end for supplying fire suppressant media to the auger, and a second opening at the opposite end for delivering the fire suppressant media, said auger being provided with an actuator for rotating said auger in order to move the fire suppressant media from the first to the second opening.

2. A fire suppressant device comprising:
a hollow tube with an electric drive motor attached at one end and an outlet at the opposing end;
a shaftless auger attached to the electric drive motor that extends inside the hollow tube towards the outlet at the opposing end; and
a port in the hollow tube through which fire suppressant media is delivered to the auger,
wherein switching on the electric drive motor turns the shaftless auger thereby transporting the media out of the outlet end for fire suppression.

3. A device for delivering granular fire suppressant media to a fire emergency site comprising a hollow tube fitted with an auger extending therein having a shank portion and a spiral portion, said hollow tube having a first opening at one end for delivering said granular fire suppressing media to a fire emergency site and second opening proximal to the other end for inputting fire suppressant media, wherein said shank portion of said auger within the hollow tube is positioned after said second opening and extends through said other end of the hollow tube, and wherein rotation of said auger delivers fire suppressant media to the fire emergency site.

4. A device according to claim 3 wherein said auger is actuated by an electric drive motor.

5. A device according to claim 4 wherein said auger is shaftless.

6. A device according to claim 4 additionally comprising a media reservoir connected to said second opening.

7. A device according to claim 6 wherein said media reservoir is detachable.

8. A device according to claim 4 wherein said first opening is a nozzle.

9. A device according to claim 8 wherein said nozzle is detachable.

10. A device according to claim 9 wherein said nozzle is rotatable.

11. A device according to claim 9 wherein said nozzle is angled.

12. A device according to claim 4 further comprising a handle positioned at said other end of the hollow tube.

13. A device according to claim 12 further comprising an additional handle between the two ends of the hollow tube.

14. A device according to claim 6 wherein the media reservoir contains free-flowing granular fire suppressant media.

15. A device according to claim 14 wherein said free-flowing granular fire suppressant media is fine powder composed of very fine glass particles.

16. A device according to claim 14 wherein the free-flowing granular fire suppressant media is expanded glass.

17. A method of delivering free-flowing granular fire suppressant media to a Li-ion fire emergency site using a device according to claim 3.

18. A method according to claim 17 wherein the free-flowing granular fire suppressant media is fine powder composed of very fine glass particles.

19. A method according to claim 17 wherein the free-flowing granular fire suppressant media is expanded glass.

20. A device according to claim 3 wherein the actuator is a mechanical handle.
